(19) United States
(12) Patent Application Publication
(10) Pub. No.: US 2015/0051961 A1
(43) Pub. Date: Feb. 19, 2015

(54) Idea Collection and Tracking System Based on Investing Game

(71) Applicant: Intelygenz Inc., Redwood City, CA (US)

(72) Inventor: José Pérez López, Corte Madera, CA (US)

(21) Appl. No.: 14/461,231

(22) Filed: Aug. 15, 2014

Related U.S. Application Data
(60) Provisional application No. 61/867,552, filed on Aug. 19, 2013.

(51) Int. Cl. G06Q 30/02

(52) U.S. Cl. CPC G06Q 30/0217; G06Q 40/06
USPC 705/14.19

(57) ABSTRACT

A system and a method are disclosed for collecting and tracking ideas. A description of an idea is received by an innovation system from an idea owner. The innovation system sends the description of the idea to multiple investors. Requests to support the idea are received by the innovation system from the investors. The requests to support the idea include an investment amount. After the aggregate investment amount from every investor is greater than a threshold, the innovation system approves the idea. The innovation system then rewards the investors that supported an approved idea.

### CROSS REFERENCE TO RELATED APPLICATIONS

This application claims the benefit of U.S. Provisional Application No. 61/867,552, filed Aug. 19, 2013, which is incorporated by reference in its entirety.

### BACKGROUND

The disclosure generally relates to the field of idea tracking and more specifically to collecting and tracking ideas based on an investing game.

Employees of a company or members of an institution oftentimes have different ideas on how to improve different aspects of the company/institution. For example, an employee of a company may have an idea on how to improve a certain product the company sells. Most of these ideas will end up not being heard by the appropriate people and its implementation might never happen.

As the company size increases, it gets more and more complicated to collect and keep track of ideas. Hence companies and/or institutions may seek for a way to encourage their employees to submit ideas and to sort them to determine which ones are the ideas worth taking a look into.

### SUMMARY

Embodiments enable the collection and tracking of ideas that users of an innovation system may have. Users provide a description of an idea to the innovation system. Other users may then provide comments about the idea or pledge virtual currency to the idea. When the aggregate amount of virtual currency pledged is larger than a threshold, the innovation system approves the idea. When the idea is approved by the innovation system, the users that pledged virtual currency to the idea are rewarded with virtual currency. The innovation system may also reward the user providing the idea.

In some embodiments, when the idea is approved by the innovation system, the description of the idea is sent to an innovation team. The innovation team may further review the description of the idea and approve or reject the idea. If the innovation team approves the idea, the users that pledged to the idea and the user that provided the idea may be further rewarded with additional virtual currency.

### BRIEF DESCRIPTION OF THE DRAWINGS

FIG. 1 is an interaction diagram of a method for collecting and tracking ideas in an innovation system, in accordance with an embodiment of the invention.

FIG. 2 is a high level block diagram illustrating a system environment suitable for operation of an innovation system, in accordance with an embodiment of the invention.

FIG. 3 is a block diagram of an innovation system, in accordance with an embodiment of the invention.

FIG. 4 is a flow chart of a method for collecting and tracking ideas, in accordance with an embodiment of the invention.

FIG. 5A is an example of a home page user interface, in accordance with an embodiment of the invention.

FIG. 5B is an example user interface of a dashboard for an inventor of the innovation system, in accordance with an embodiment of the invention.

FIG. 6A and 6B are an example user interface for providing new ideas to the innovation system, in accordance with an embodiment of the invention.

FIG. 7 is an example user interface for displaying an idea published in the innovation system, in accordance with an embodiment of the invention.

FIG. 8A is an example user interface for requesting to be added to an idea team, in accordance with one embodiment of the invention.

FIG. 8B is an example user interface for accepting or rejection a request to be added to an idea team, in accordance with on embodiment of the invention.

FIG. 9 is an example user interface for displaying a list of user connections and a newsfeed, in accordance with an embodiment of the invention.

FIG. 10A is an example user interface for displaying the distribution of a user investment portfolio, in accordance with an embodiment of the invention.

FIG. 10B is an example user interface for displaying the profitability of a user investment portfolio, in accordance with an embodiment of the invention.

FIG. 11 is an example user interface for displaying the balance statement of a user of the innovation system, in accordance with an embodiment of the invention.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

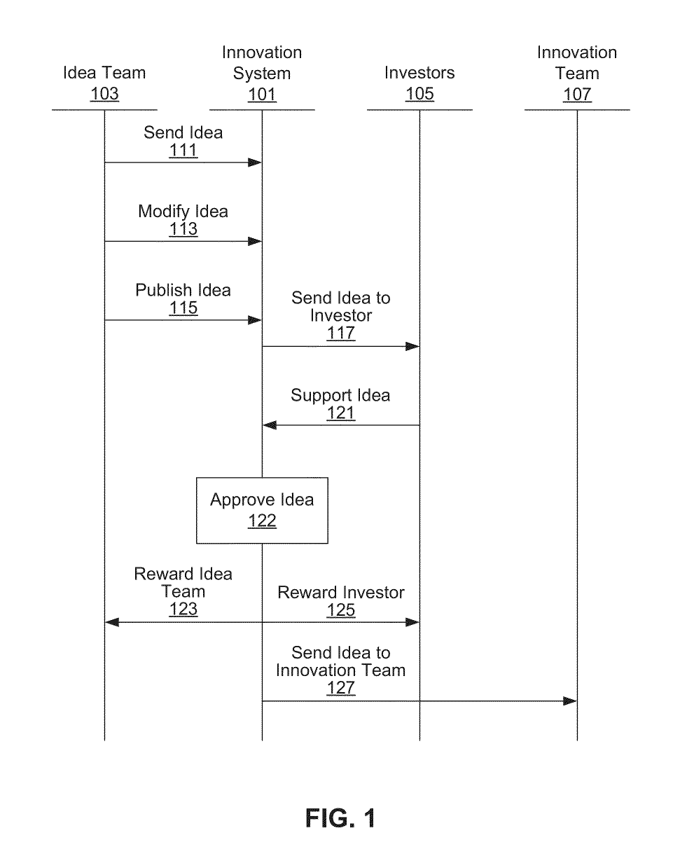

FIG. 1 is an interaction diagram of a method for collecting and tracking ideas in an innovation system 101. Users of the innovation system can submit ideas and/or view ideas submitted by other users. For example, a first user may submit an idea on how to improve a certain product sold by a company. Other users may be able to see and comment on the idea. In one embodiment, the users of the innovation system 101 are the employees of a certain company. In some embodiments, users may also be customers of a certain company that would like to provide ideas for a new product or ideas on how to improve a product. Ideas may be submitted to the innovation system 101 by a single user, or a group of users.

In the example of FIG. 1, an idea team 103 sends 111 an idea to the innovation system 101. As used herein, an idea team is a user or group of user that submits and/or works on an idea in the innovation system 101. In some embodiments, users can join or leave the idea team after an idea has been sent to the innovation system 101. For example, a user browsing ideas may request to join the idea team 103. If the idea team accepts the request, the user is granted access to work on the idea. After an idea has been sent to the innovation system 101, members of the idea team 103 may modify 113 the idea. For example, team members may be able to change the details of the idea, the description of the idea, the objectives of the idea, an image representing the idea, a video pitching the idea, and the like. After the idea has been modified, the idea is published 115. In some embodiments, users that are not members of the idea team 103 are not able to see the idea until the idea is published 115.

In some embodiments, to publish an idea, an initial investment is required. The initial investment may be set by the innovation system 101 and may be provided by the members of the idea team 103. For example, the innovation system 101 may require an initial investment of $5,000 to publish an idea. Each of the members of the idea team may provide a portion of the initial investment needed. In some embodiments, the innovation system may limit the amount of investment that can be provided by members of the idea team (e.g., the members of the idea team can only invest up to 25% of the investment needed for approval).

After the idea has been published 115, the idea may be sent to investors 105. As used herein, investors are users of the innovation system 101 that can support ideas. In one embodiment, any user of the innovation system can support an idea. In other embodiments, only a subset of users can support an idea (e.g., an idea related to marketing can only be supported by employees that work in the marketing department).

Investors that received the idea may review them and comment on the idea. An investor may then support 121 the idea. In some embodiments, an investor supports an idea by pledging or investing virtual currency. In other embodiments, an investor supports an idea by pledging or investing real currency. In some embodiments, the investors can invest any amount of currency. In other embodiments, investors can only invest up to a predefined amount of currency (e.g., up to 5% of the investment needed for approval). In yet other embodiments, investors can only invest a predefined amount of currency (e.g., a single investor can only invest $1,000 per idea).

When the support received by an idea is greater than a threshold, the innovation system 101 approves the idea. In one embodiment, the innovation system approves an idea after the total amount invested in the idea is greater than a threshold. For example, an idea might get approved after it has received a total investment of $1,000,000. In another example, an idea might get approved after it has received a total investment equivalent to 10% of the total currency available in the innovation system 101. In some embodiments, if an idea does not get the necessary support within a predetermined amount of time, the innovation system 101 may reject the idea.

If an idea gets approved the innovation system 101 rewards 123 the idea team and rewards 125 the investors that supported the idea. In one embodiment, the innovation system 101 rewards the idea team and the investors that supported the idea by compensating them with virtual currency. In other embodiments, the innovation system 101 rewards the idea team 103 and the investors 105 that supported the idea by compensating them with real currency. For example, the innovation system 101 may reward 123 the idea team 103 by awarding them a predefined amount of virtual currency for submitting and/or working on the idea. In some embodiments, the innovation system 101 rewards different amount of virtual currency to idea team members based on seniority, or based on the amount of time the user has been part of the idea team 103. In one embodiment, the innovation system 101 may award a predefined amount of virtual currency to the users that sent 111 the idea and another predefined amount of virtual currency to users that modified 113 or worked on the idea.

Further, the innovation system 101 may reward 125 the investors 105 that supported the idea by awarding them an amount of virtual currency based on the amount of virtual currency they invested on the idea (e.g., two times the amount invested on the idea). In some embodiments, the innovation system 101 rewards the investors 105 based on how early they supported 121 the idea (e.g., the innovation system 101 may award 3 times the invested amount to investors 105 that supported the idea before the idea had a total investment less than half of the investment needed for approval, and 2 times the invested amount to investors 105 that supported the idea after the idea had a total investment greater than half of the investment needed for approval).

In some embodiments, the innovation system may also provide badges and/or trophies to members of the idea team and/or the investors for completing certain action. For instance, a badge or a trophy may be provided to an investor that invested in at least a threshold number of ideas (e.g., 5 ideas) that were approved by the innovation system 101.

After the idea has been approved, the innovation system 101 also sends 127 the idea to the innovation team 107. As used herein, the innovation team 107 is a user, or group of users that receives approved ideas and reviews them to determine whether to implement it or not. The innovation team 107 may approve or reject the idea. For example, the innovation team 107 may reject an idea if the idea does not line up with the company business goals.

### System Architecture

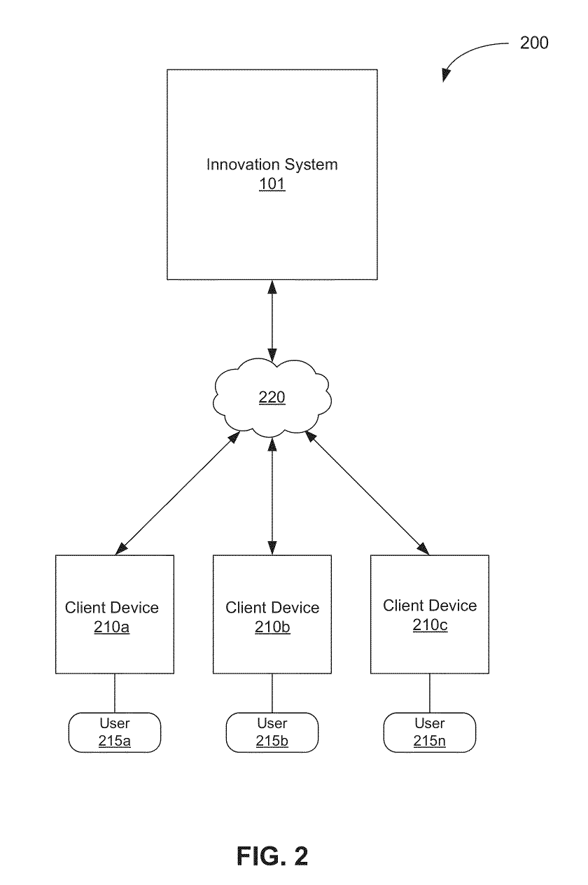

FIG. 2 is a block diagram of a system environment 200 for an innovation system 101. The system environment 200 shown by FIG. 2 comprises one or more client devices 210, operated by clients 215, a network 220, and the innovation system 101. In alternative configurations, different and/or additional components may be included in the system environment 200.

The client devices 210 are one or more computing devices capable of receiving user input as well as transmitting and/or receiving data via the network 220. In one embodiment, a client device 210 is a conventional computer system, such as a desktop or a laptop computer. Alternatively, a client device 210 may be a device having computer functionality, such as a personal digital assistant (PDA), a mobile telephone, a smartphone or another suitable device. A client device 210 is configured to communicate via the network 220. In one embodiment, a client device 210 executes an application allowing a user of the client device 210 to interact with the innovation system 101. For example, a client device 210 executes a browser application to enable interaction between the client device 210 and the innovation system 101 via the network 220. In another embodiment, a client device 210 interacts with the innovation system 101 through an application programming interface (API) running on a native operating system of the client device 210, such as IOS® or ANDROID™.

The client devices 210 are configured to communicate via the network 220, which may comprise any combination of local area and/or wide area networks, using both wired and/or wireless communication systems. In one embodiment, the network 220 uses standard communications technologies and/or protocols. For example, the network 220 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 220 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 220 may be represented using any suitable format, such as hypertext markup language (HTML) or extensible markup language (XML). In some embodiments, all or some of the communication links of the network 220 may be encrypted using any suitable technique or techniques.

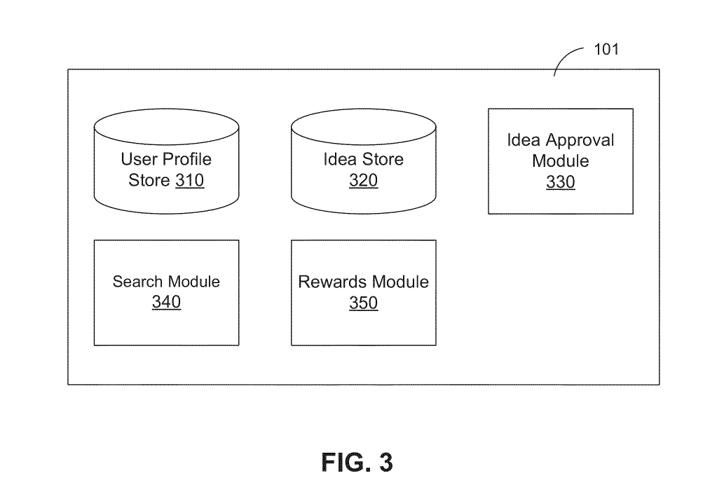

FIG. 3 is an example block diagram of an architecture of the innovation system 101. The innovation system 101 shown in FIG. 3 includes a user profile store 310, an idea store 320, and idea approval module 330, a search module 360, and a reward module 350. In other embodiments, the innovation system 101 may include additional, fewer, or different components for various applications. Conventional components such as network interfaces, security functions, load balancers, failover servers, management and network operations consoles, and the like are not shown so as to not obscure the details of the system architecture.

Each user of the innovation system 101 is associated with a user profile, which is stored in the user profile store 310. A user profile includes declarative information about the user that was explicitly shared by the user and may also include profile information inferred by the innovation system 101. In one embodiment, a user profile includes multiple data fields, each describing one or more attributes of the corresponding user of the innovation system 101. Examples of information stored in a user profile include biographic, demographic, and other types of descriptive information, such as work experience, educational history, gender, location and the like.

In some embodiments, users link use a third party user profile as their user profile in the innovation system 101. For example, users may link a social networking system user profile (e.g., FACEBOOK, GOOGLE+, SALESFORCE CHATTER, YAMMER, etc.). Users may log-in to the innovation system 101 using authentication information from the third party system. For instance, users may be able to log-in to the innovation system 101 using their GOOGLE+ log-in information. In some embodiments, the authentication may be done using an application programming interface (API) provided by the third party system.

A user profile may also include data indicating the amount of virtual currency the user possess to invest on ideas. When a user account is created, the innovation system 101 may assign a predetermined amount of virtual currency to the user. In some embodiment, the amount of virtual currency assigned to the user is the same for all users of the innovation system 101. In other embodiments, the amount of money assigned to the user may be based on seniority, title/position, and/or the like. In some embodiments, the innovation system may assign additional virtual currency to a user to encourage investment. A user 215 may also obtain virtual currency by performing certain actions in the innovation system 101. For example, the innovation system 101 may award a user a predetermined amount of virtual currency for commenting on an idea submitted by other user of the innovation system 101.

In some embodiments, the innovation system 101 may deduct virtual currency from the user profile every predetermined amount of time (e.g., every month). In one embodiment, the innovation system 101 only deducts virtual currency for users that have not performed any actions in the innovation system 101. This action may incentive users to submit ideas, post comments, and/or support an idea.

In some embodiments, users of the innovation system 101 may establish connections with other users of the innovation system 101. After establishing a connection, the user may be able to follow the activities performed by those connections. For example, the innovation system 101 may provide a newsfeed with information related to actions of those connections, such as ideas those connections have invested on, ideas those connections have commented on, ideas submitted by those connections, and the like.

Connection may be created automatically by the innovation system 101 for users that are part of the same idea team, when a user sends an idea to another user, when a user invests on an idea created by another user, when a user likes and idea or comment provided by another user, and the like.

The idea store 320 stores ideas submitted by users of the innovation system 101. The idea store 320 may also contain information related to the ideas such as title, description, team members, image, strategic goals, pledged amount, comments, and the like. The idea store 320 may also include information about the state of the idea (e.g., unpublished, published, approved, rejected, pilot, launched, etc.).

The idea approval module 330 is configured to approve or reject ideas after they are published. The idea approval module approves an idea when the idea has received more than a threshold amount of support from investors. For example, the idea approval module may approve ideas after investors have invested more than a threshold amount of virtual currency (e.g., $1,000,000). In some embodiments the threshold amount of support is a percentage (e.g., 5%) of the virtual currency available in the innovation system 101.

Embodiments of the idea approval module reject ideas that have not received the necessary amount of support within a predetermined amount of time (e.g., 30 days). In some embodiments, the idea approval module approves a predefined number of ideas every set amount of time. For example, every month, the idea approval module 330 may approve the top 10% ideas (based on amount pledged) that have been published in the previous month, and reject the bottom 90% of ideas that have been published in the same time frame.

The rewards module 350 is configured to compensate users for performing different actions in the innovation system 101. For example, the reward module may compensate users for posting comments on ideas. The reward module 350 may also award virtual currency to users that invested on an idea that got approved by the idea approval module 330. Additionally, the reward module 350 may reward users that submitted ideas or worked on ideas that got approved by the idea approval module 330. The reward module 350 may also reward investors 105 and members of the idea team 103 after the innovation team 107 approves the idea, a pilot is launched, or the idea is deployed.

For example, the rewards module 350 may reward an investor that invested on an idea by multiplying the invested amount by a first factor (N1) when the idea gets the necessary funding for approval, by multiplying the invested amount by a second factor (N2) when the idea gets approved by the innovation team, etc.

The search module 340 is configured to receive search queries and return ideas that match the search query. In some embodiments, the search module 340 does not include unpublished ideas or rejected ideas in the search results. Users may, for example, perform searches based on date published, amount pledged, business goals, and the like.

The search module 340 may also be configured to search for potential investors based on search queries provided by members of an idea team. For example, an idea team member may search for investors that are interested in a particular topic, investors with at least a threshold amount of money, investors that frequently use the innovation system 101, and the like. Idea team members may then contact the investors so they can invest on the idea.

### Collection and Tracking of Ideas

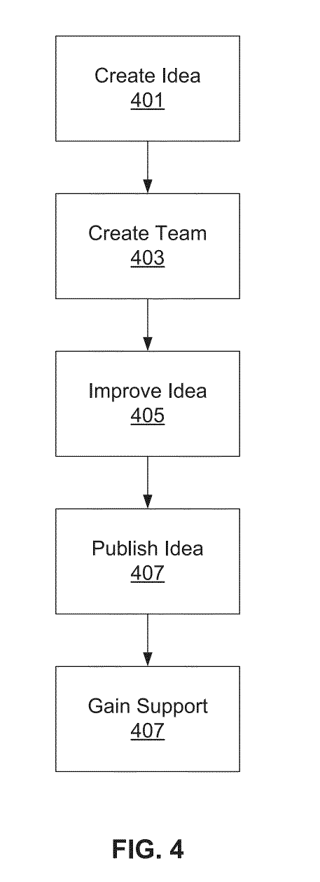

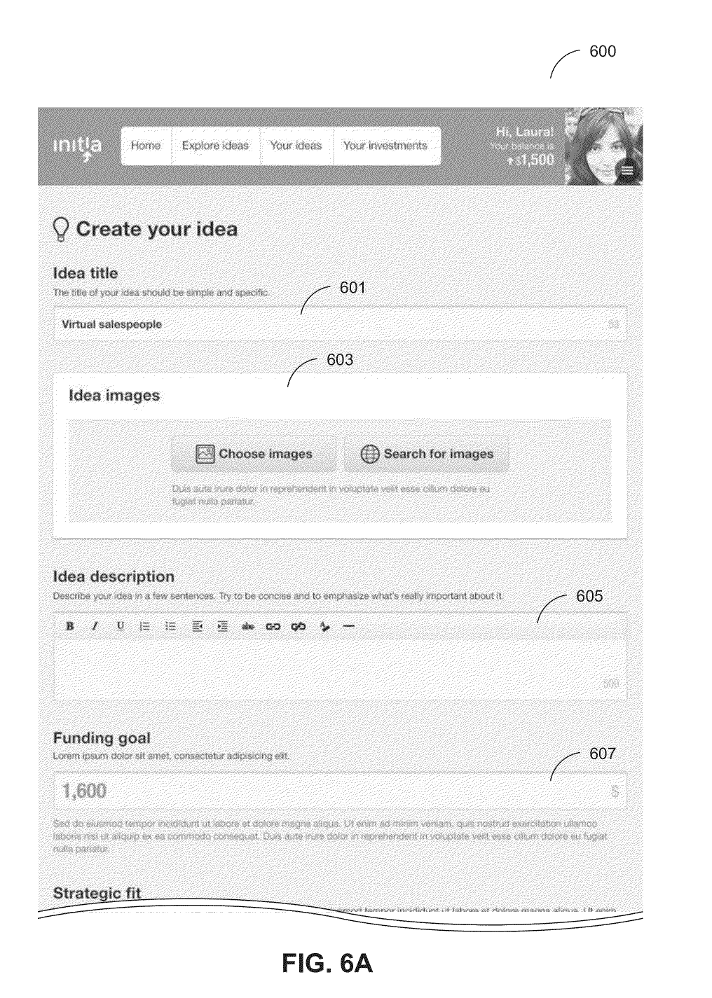

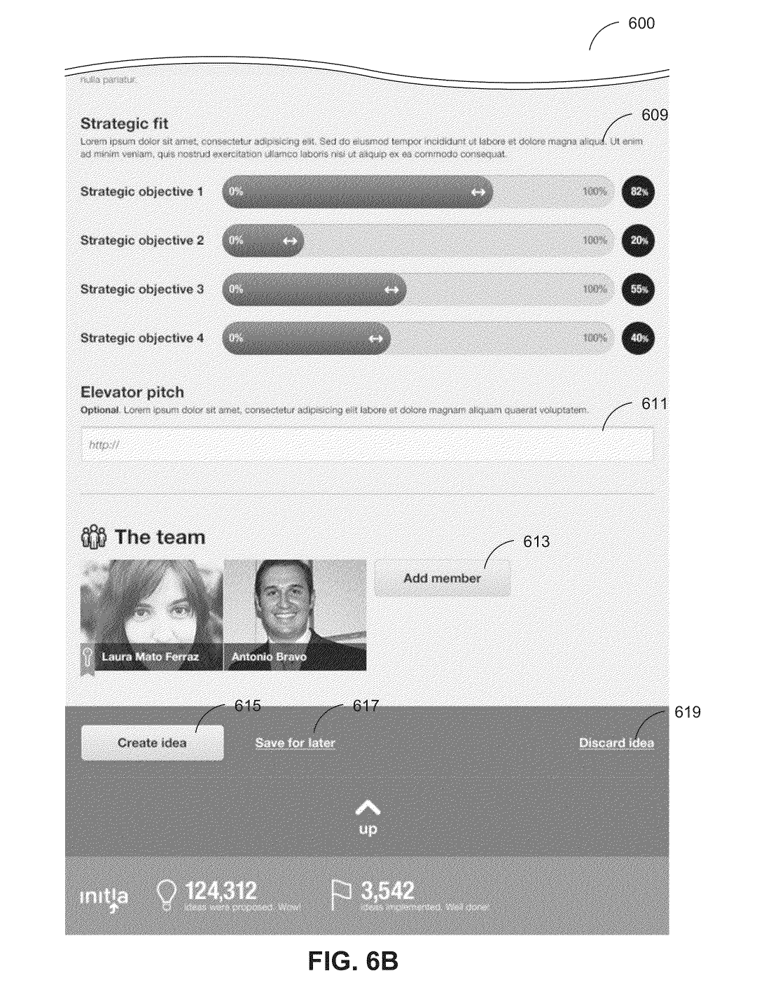

FIG. 4 is a flow chart of a method for collecting and tracking ideas. A user creates 401 an idea. A user interface illustrating for creating an idea is shown in conjunction with FIG. 6A and 6B. After the user has created the idea, the user can create 403 an idea team. In some embodiments, the user creating the idea can send request to other users to join the idea team. If the other users accept the request, they are added to the idea team and they are granted access to modify the idea.

The idea team members improve 405 the idea. Members can for example, modify the description of the idea, the business goals of the idea, the image representing the idea, the elevator pitch of the idea, and the like. In some embodiments, the innovation system 101 may provide a communication channel (e.g., a chat room) for team members to discuss on improvements to the idea.

The idea is then published 407. When an idea is published, it becomes visible to other users of the innovation system 101. Users can the comment on the idea, invest on the idea, etc. In some embodiments, after the idea has published, the idea team cannot modify or improve the idea. In other embodiments, even after the idea has published team members may be able to modify and/or improve the idea.

The idea then gains 407 supports from investors. Investors may invest or pledge virtual money to ideas that they think are likely to be approved. Support can be gained passively or actively. Support is obtained passively when investors find the idea using the search module 340 and pledges to that idea. Support can also be obtained actively, by sending the idea to investors and requesting for their support. For example, a team member can search for investors that have interests aligned to the topic of the idea. Ideas that obtain more than a threshold amount of support are approved by the idea approval module 330. In some embodiments, approved ideas are sent to an innovation team for further review.

The innovation team may review the idea according to different criteria and may approve or reject the idea. The criteria used by the innovation team may include business goals of the idea, budget needed to deploy the idea, feasibility of the idea, and the like. If the innovation team approves the idea, a pilot team to develop a pilot implementation of the idea may be created. In some embodiments, the pilot team is the idea team that published the idea. The pilot team develops a pilot implementation, and if the pilot implementation is successful, the idea may be deployed.

### User Interface

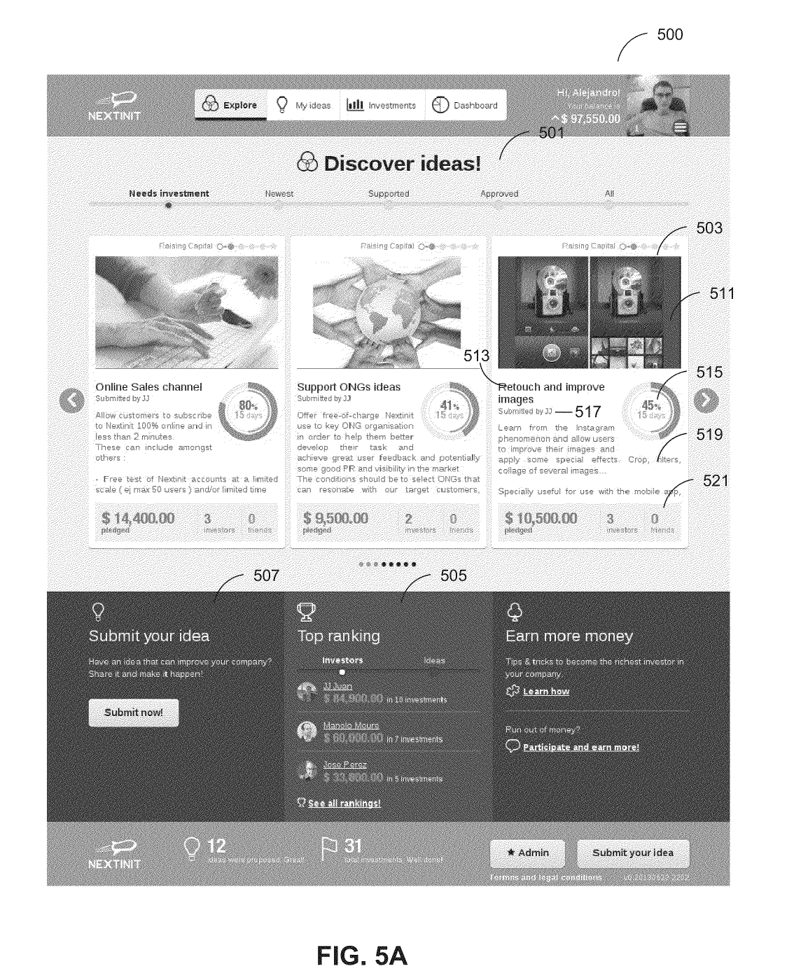

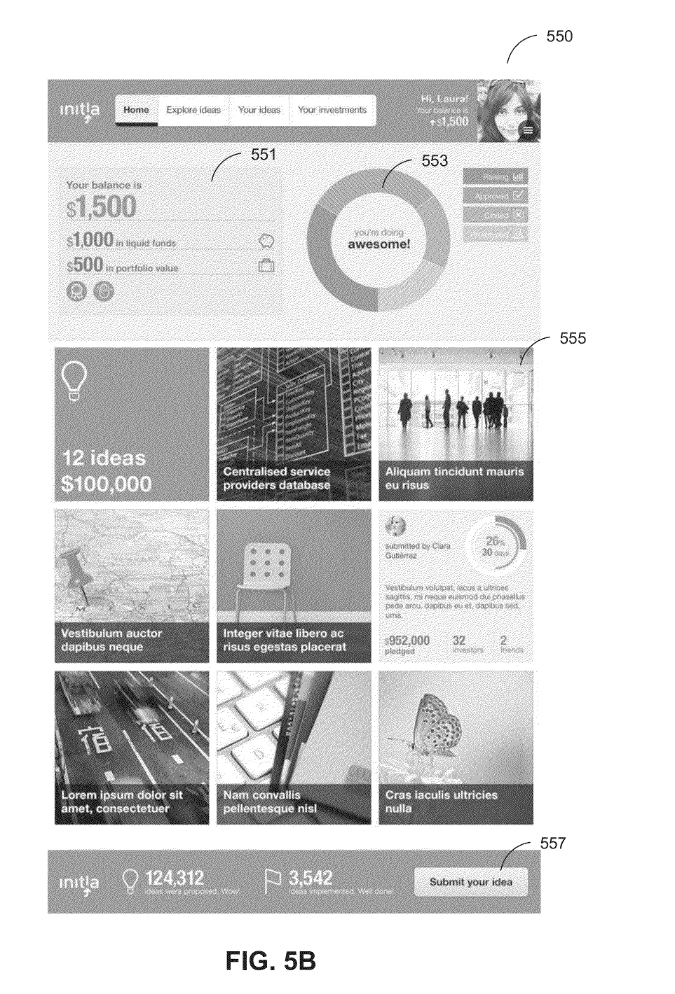

FIG. 5A shows an exemplary user interface of a home page 500 for a user of the innovation system 101. The home page 500 includes user interface components that allow a user of the innovation system 101 to search for ideas. For example the user can sort ideas, or submit search queries using the search bar 501. After providing a search query and/or sorting criteria, the home page 500 displays information about published ideas 503 that match the search query. The home page 500 may display an image 511 representing the idea, the title 513 of the idea, the author 517 of the idea, the number of days before the idea is rejected 515, a description of the idea 519, investment information 521 (e.g., amount pledged, number of investors, etc), and the like. Further, the home page 500 may allow users to see the top ranking 505, such as, which investors have earned the most amount of virtual currency and/or which ideas are receiving the most amount of investment. The home page 500 may also include user interface components that allow users to submit new ideas to innovation system 101.

FIG. 5B show an exemplary user interface of a dashboard 550 for an investor of the innovation system 101. The dashboard 550 displays information regarding the investments the investor currently has. The dashboard 550 may include information about the investor current balance 551, including liquid funds and portfolio value; a chart 553 displaying the allocation of the investor virtual currency in the investor portfolio, and a list of ideas 555 the investor has invested on. In some embodiments, the list of ideas 555 is an array of images associated with the ideas. In one embodiment, the dashboard 555 displays additional information about the idea when the investor clicks an image associated with an idea or hovers the cursor on top of an image associated with an idea. The dashboard 550 may also include a button 557 that allow users to submit new ideas to innovation system 101.

FIGS. 6A and 6B show an exemplary user interface (UI) 600 to provide new ideas to the innovation system 101. The idea creation UI 600 includes components to add a title 601, an image 603 related to the idea, a description 605 of the idea, a funding goal 607 of the idea, the strategic fit 609 of the idea, an elevator pitch 611 for the idea, and a list of idea team members 613 that can work on the idea. Furthermore, the idea creation UI 600 may include buttons to create 615 or publish the idea, save 617 the idea for later, and/or discard 619 the idea.

In some embodiments, the image selection UI component 603 allows user to choose images saved in the user local drive, choose an image from a list of preselected images, search images on the web, and the like. In one embodiment, if the user does not select an image for the idea, the idea creation UI may select a default image to be associated with the idea.

The funding goal is the amount of investment the idea needs for approval by the idea approval module 330. In some embodiments, the user may be able to set the funding goal 607. In other embodiments, the innovation system determines the funding goal needed to obtain approval by the idea approval module 330. For instance, the innovation system 101 may set the funding goal to a predetermined value (e.g., $1,000,000) or to a value equal to a percentage (e.g., 5%) of the total amount of virtual currency available in the innovation system 101.

The strategic fit or business goals of the idea illustrate how relevant the idea is to the goals of the company or institution. In some embodiments, the list of business goals are predefined and a user may specify a how relevant the idea is to each business goal in the list. In other embodiments, the user may provide his own set of business goals and may specify how relevant the idea is to each of those business goals. In one embodiment, the user can set a percentage anywhere from 0% to 100% for each of the business goals. In another embodiment, the percentages assigned to all of the business goals can only add up to 100%.

The elevator pith is a short video pitching the idea to investors of the innovation system 101. In some embodiments, the user can upload a video to be used as the elevator pitch. In other embodiments, the user can specify a uniform resource locator (URL) of the video to be used as the elevator. In yet other embodiments, the idea creation UI 600 may allow the user to record the elevator pitch video using a webcam.

The idea creation UI 600 also allows users to add members to the idea team. Members of the idea team can post comments and modify the idea before the idea is published. The user creating the idea can request other users to join the idea team. In one embodiment, only the user that created the idea can add members to the idea team. In other embodiments, any member of the idea team can add members to the idea team.

Users can also save the idea for later, discard the idea and/or create (publish) the idea. Saving the idea for later saves the idea in the idea store 320 without publishing it. Team members can still access the idea and make changes to the idea. Discard the idea removes the idea from the idea store 320, and therefore makes the idea inaccessible to users of the innovation system 101. Creating or publishing the idea makes the idea available to users that are not part of the idea team (e.g., investors). In some embodiments, after the idea has been published, members of the idea team cannot make further modifications to the idea.

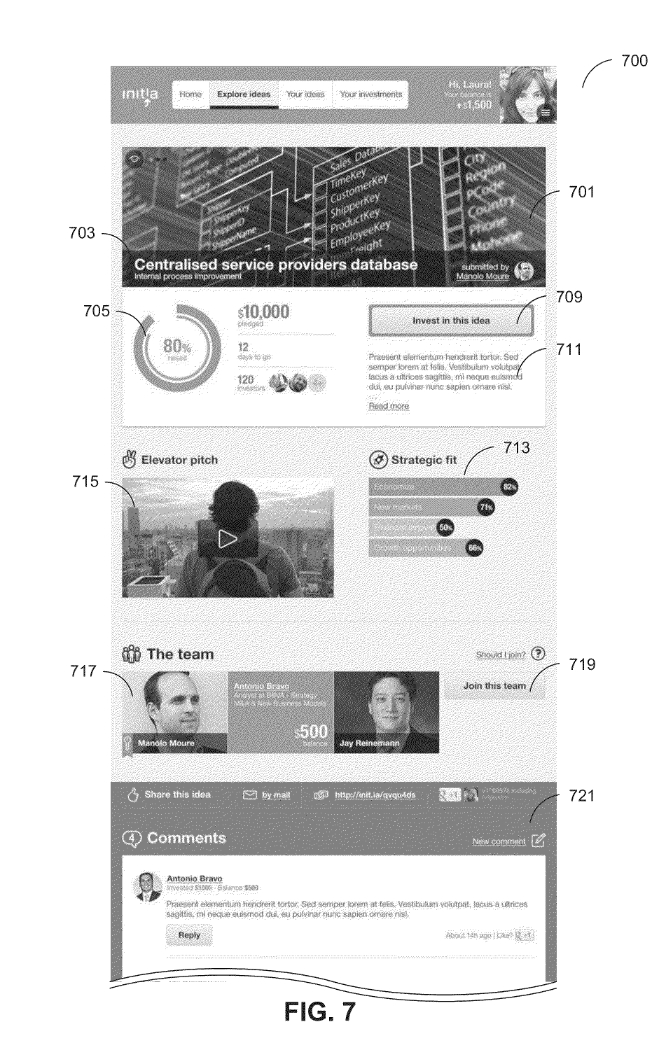

FIG. 7 shows an exemplary user interface 700 displaying an idea published in the innovation system 101. The idea UI 700 includes user interface components for displaying an image 701 associated with the idea, the title 703 of the idea, a description 711 of the idea, the strategic fit 713 of the idea, the elevator pitch 715 of the idea and a list of the members of the idea team 717.

Additionally the idea UI 700 displays investment information 705, such as the amount of virtual currency pledged to the idea, the number of investors that have pledged to the idea, the percentage of investment raised needed for approval, the number of days before the idea is rejected for lack of support, and the like. The idea UI 700 also includes a field to allow investors to invest on the idea 709.

The idea UI 700 allows users to post comments 721 about the idea. Users may also be able to rate the idea (e.g., from one to five stars) or rate a comment. In some embodiments, users can also reply to ideas. Users may also be able to send emails or private messages to members of the idea team that would not be shown to other users of the innovation system 101.

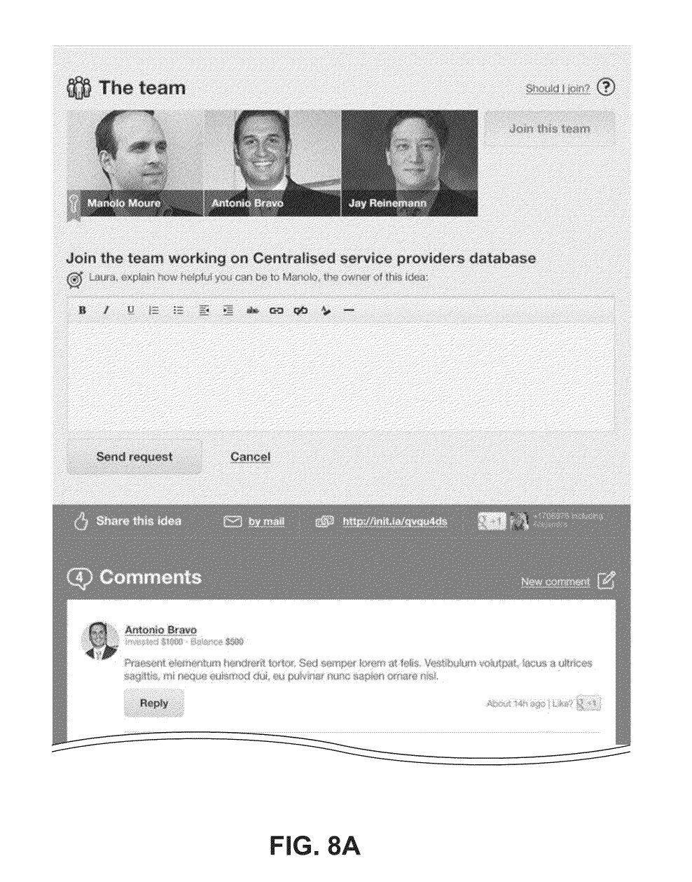

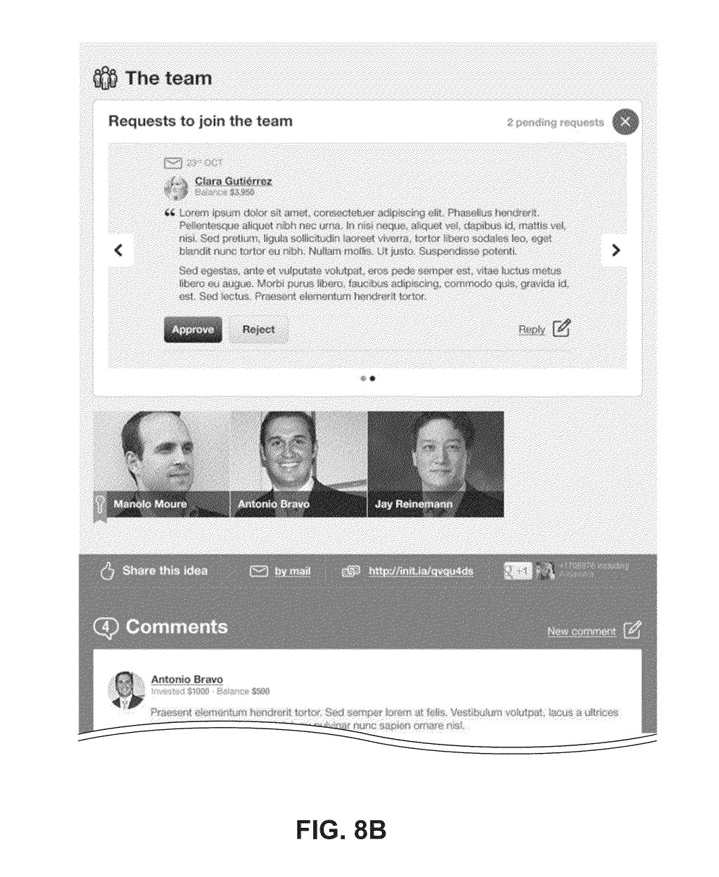

FIG. 8A shows a user interface to request to be added to the idea team. Users may be able to send a message explaining why it would be useful for them to be added to the idea team. For example, the user can give a description of his work experience, area of expertise, and the like. The user that created the idea receives the request, as shown in FIG. 8B, and can accept or reject the request. In some embodiments, the user that created the idea might send a message back to the user trying to join the idea team to ask for more information. In one embodiment, if the request is rejected, the user rejecting the request may specify a reason for the rejection.

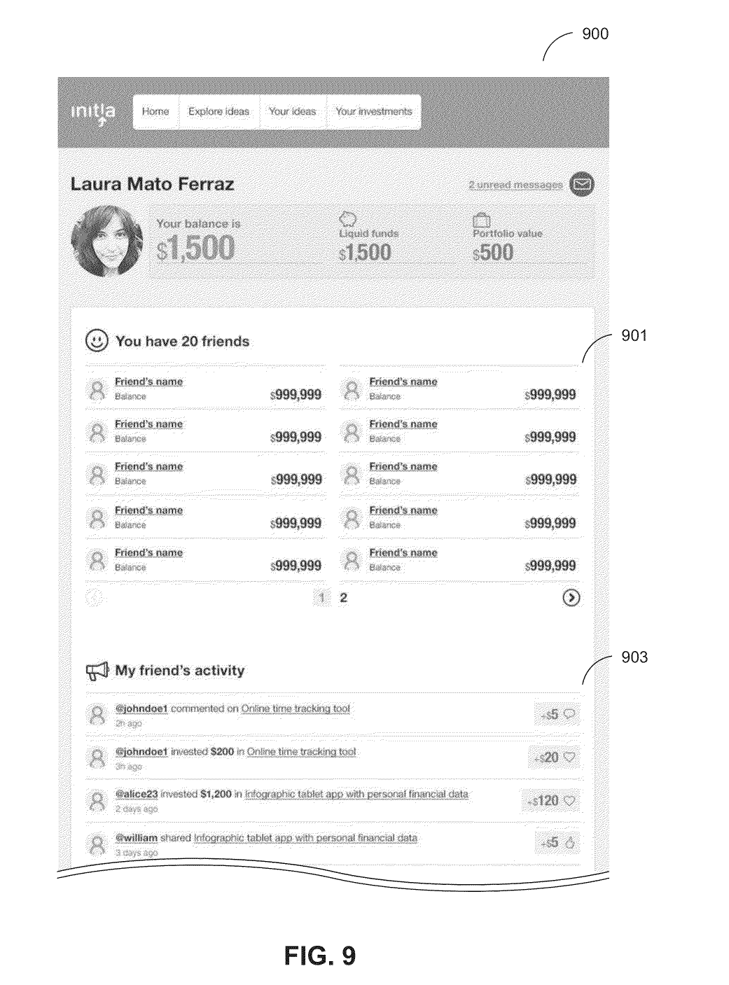

FIG. 9 shows a user interface displaying a list of a user connections 901, as well as a newsfeed 903 notifying the user of different events that happened in the innovation system 101. The list of connections 901 may also display the virtual currency balance of each of the connections. The newsfeed 903 lists the most recent activities related to connections of the user. For example, the newsfeed 903 may show information regarding connections that have recently invested on an idea, connections that have been recently rewarded, connections that have recently created an idea, and the like. In some embodiments, the user may be able to post comments on items appearing in the newsfeed 903.

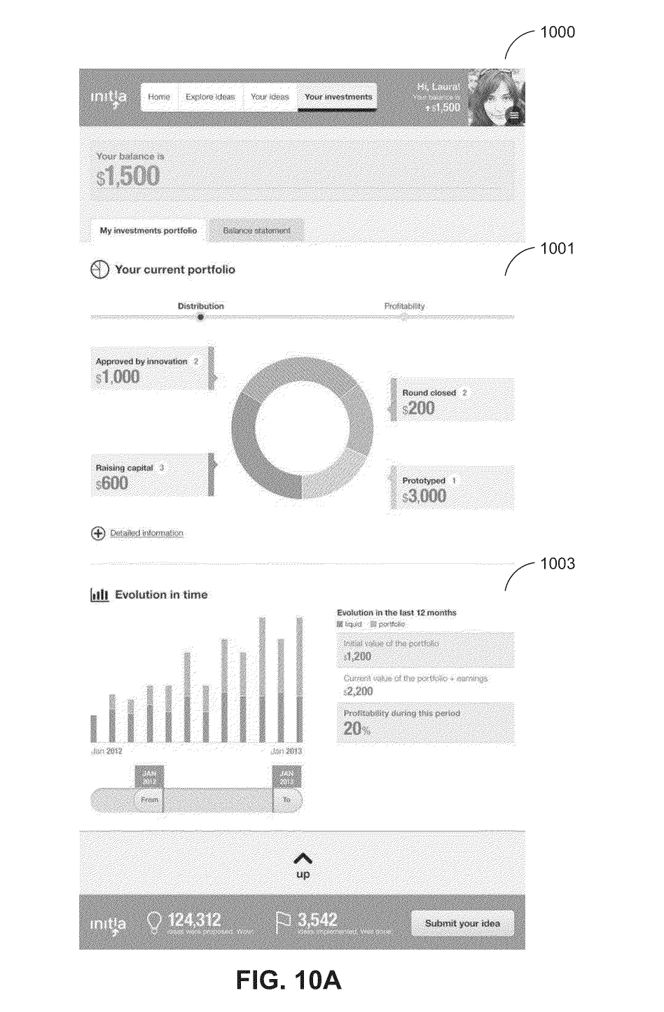

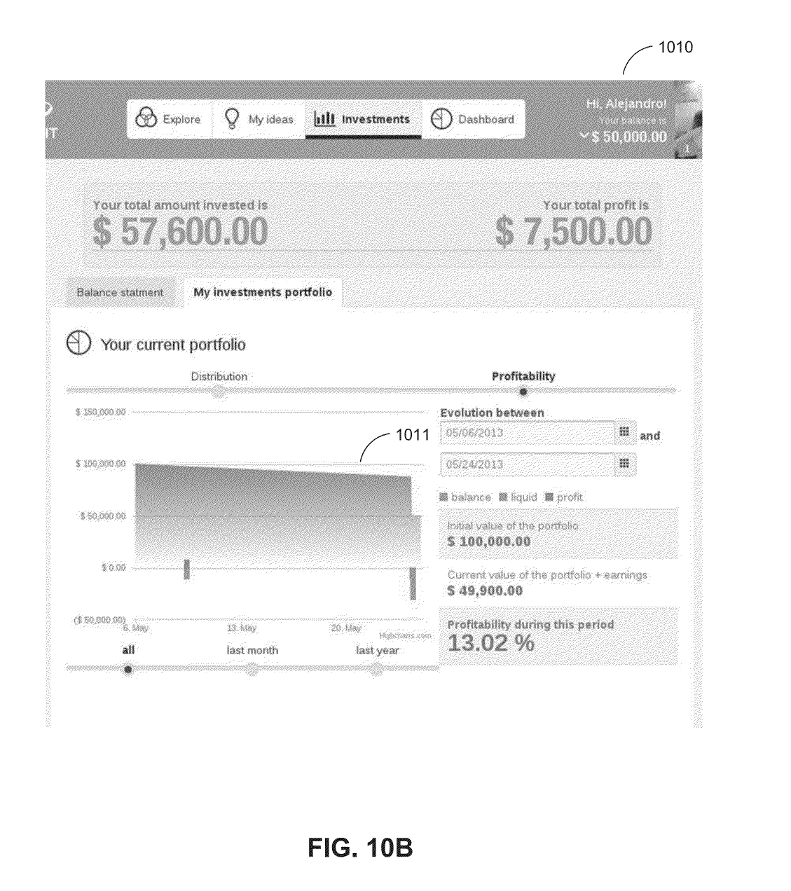

FIG. 10A shows a user interface 1000 displaying the distribution of a user investment portfolio. In one embodiment, the investment portfolio distribution UI 1000 shows the user current portfolio 1001 as well as the user assets as a function of time 1003. For example, as illustrated in FIG. 10A, the current portfolio 1001 section of the UI 1000 shows how the user virtual currency is split among different ideas. As shown in FIG. 10A, the user has invested a total of $600 on three ideas that are currently raising capital, $1000 on two ideas that have been approved by the innovation team, $200 on two ideas that have finished raising capital, and $3000 on one idea that is being prototyped.

The user interface 1000 also shows the evolution of the user assets as a function of time. For example, the user interface 1000 of FIG. 10A shows the evolution of user assets from January 2012 to January 2013. The UI 1000 shows the initial value of the portfolio (e.g., $1,200), the current value of the portfolio (e.g., $2,200) and the profitability of the portfolio (e.g., 20%). The UI 1000 also shows a bar diagram showing the amount of virtual currency the user had in liquid funds and the amount of currency the user had in portfolio value for every month in the selected time frame.

FIG. 10B shows a user interface 1010 displaying the profitability of a user investment portfolio. In one embodiment, the profitability UI 1010 shows the evolution of the user assets as a function of time. For instance, the UI 1010 shows a graph 1011 displaying the change in the user portfolio value from May 6, 2013 to May 24, 2013.

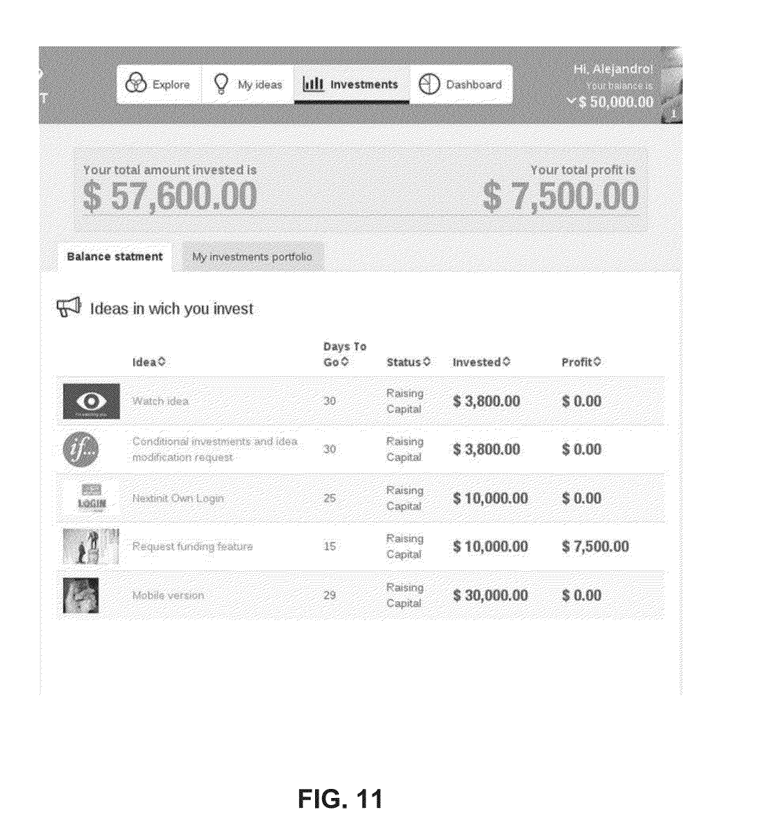

FIG. 11 shows a user interface showing the balance statement of a user of the innovation system 101. The balance statement shows a list of the recent transactions (e.g., inflows and outflows of virtual currency for the user). In some embodiments, the statement balance shows the date of the transaction, the transaction amount, the new balance, and a description of the transaction. In some embodiments, the balance statement only shows transactions performed within a specific amount of time (e.g., within the past month). In other embodiments, the balance statement shows predefined number of past transactions (e.g., last 10 transactions)

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer readable storage medium or any type of media suitable for storing electronic instructions, and coupled to a computer system bus. Furthermore, any computing systems referred to in the specification may include a single processor or may be architectures employing multiple processor designs for increased computing capability.

Embodiments of the invention may also relate to a computer data signal embodied in a carrier wave, where the computer data signal includes any embodiment of a computer program product or other data combination described herein. The computer data signal is a product that is presented in a tangible medium or carrier wave and modulated or otherwise encoded in the carrier wave, which is tangible, and transmitted according to any suitable transmission method.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving a description of an idea from an idea owner;
sending the description of the idea to a plurality of investors;
receiving a request from one or more investors of the plurality of investors to support the idea, the request including an investment amount;
responsive to an aggregate investment amount from every investor that sent a request to support the idea being greater than a threshold, approving the idea; and
responsive to approving the idea, rewarding the one or more investors that sent a request to support the idea.

2. The method of claim 1, further comprising:
assigning a pre-determined amount of virtual currency to the plurality of investors; and
responsive to receiving the request to support the idea, decreasing the amount of virtual currency owned by the investor by the investment amount.

3. The method of claim 2, wherein rewarding the one or more investors that sent a request to support the idea comprises:
increasing the amount of virtual currency owned by the investor based on the investment amount.

4. The method of claim 1, further comprising:
responsive to approving the idea, rewarding the idea owner.

5. The method of claim 4, wherein rewarding the idea owner comprises increasing the amount of virtual currency owned by the idea owner by a set amount.

6. The method of claim 1, further comprising:
responsive to approving the idea, sending the description of the idea to an innovation team.

7. The method of claim 6, further comprising:
receiving a request from the innovation team to approve the idea; and
responsive to receiving the request from the innovation team to approve the idea, rewarding the one or more investors and the idea owner.

8. The method of claim 1, further comprising:
receiving a comment for the idea from a user; and
responsive to receiving the comment, rewarding the user by increasing an amount of virtual currency owned by the user by a set amount.

9. The method of claim 1, further comprising:
responsive to the aggregate investment amount from every investor that sent a request to support the idea being lower than a threshold after a set amount of time, rejecting the idea.

10. The method of claim 1, wherein the description of the idea comprises at least one of a written description of the idea, a pitch video and a set of strategic goals.

11. A non-transitory computer readable medium storing instructions, the instructions when executed by a processor cause the processor to:
receive a description of an idea from an idea owner;
send the description of the idea to a plurality of investors;
receive a request from one or more investors of the plurality of investors to support the idea, the request including an investment amount;
responsive to an aggregate investment amount from every investor that sent a request to support the idea being greater than a threshold, approve the idea; and
responsive to approving the idea, reward the one or more investors that sent a request to support the idea.

12. The non-transitory computer readable medium of claim 11, wherein the instruction further cause the processor to:
assign a pre-determined amount of virtual currency to the plurality of investors; and
responsive to receiving the request to support the idea, decrease the amount of virtual currency owned by the investor by the investment amount.

13. The non-transitory computer readable medium of claim 12, wherein rewarding the one or more investors that sent a request to support the idea comprises:
increasing the amount of virtual currency owned by the investor based on the investment amount.

14. The non-transitory computer readable medium of claim 11, wherein the instructions further cause the processor to:
responsive to approving the idea, reward the idea owner.

15. The non-transitory computer readable medium of claim 14, wherein rewarding the idea owner comprises increasing the amount of virtual currency owned by the idea owner by a set amount.

16. The non-transitory computer readable medium of claim 11, wherein the instructions further cause the processor to:
responsive to approving the idea, send the description of the idea to an innovation team.

17. The non-transitory computer readable medium of claim 16, wherein the instructions further cause the processor to:
receive a request from the innovation team to approve the idea; and
responsive to receiving the request from the innovation team to approve the idea, reward the one or more investors and the idea owner.

18. The non-transitory computer readable medium of claim 11, wherein the instructions further cause the processor to:
receive a comment for the idea from a user; and
responsive to receiving the comment, reward the user by increasing an amount of virtual currency owned by the user by a set amount.

19. The non-transitory computer readable medium of claim 11, wherein the instructions further cause the processor to:
responsive to the aggregate investment amount from every investor that sent a request to support the idea being lower than a threshold after a set amount of time, reject the idea.

20. The non-transitory computer readable medium of claim 11, wherein the description of the idea comprises at least one of a written description of the idea, a pitch video and a set of strategic goals.
